(19) United States
(12) Patent Application Publication
(10) Pub. No.: US 2026/0309348 A1
(43) Pub. Date: Oct. 8, 2026

(54) PORTABLE ELECTRIC WAX MELTING DEVICE

(71) Applicant: SHIH-GANG TSENG, Taipei City (TW)

(72) Inventor: SHIH-GANG TSENG, Taipei City (TW)

(21) Appl. No.: 19/567,058

(22) Filed: Mar. 14, 2026

Related U.S. Application Data
(60) Provisional application No. 63/776,021, filed on Mar. 22, 2025.

(51) Int. Cl. F24F 8/50; H04R 1/02; H05B 3/42

(52) U.S. Cl. CPC F24F 8/50; H04R 1/028; H05B 3/42; H05B 2203/021

(57) ABSTRACT

A portable electric wax melting device includes a main unit base, a removable cup body, and a removable lid body. The base has a housing with a control module, a heating pad on an upper surface, and a heating rod extending vertically through a center of the heating pad. A temperature control module is electrically connected to the heating pad and the heating rod, a battery module is electrically connected to the temperature control module, and a charging management module is electrically connected to the battery module, with the control module also electrically connected to the temperature control module and the charging management module. The cup body has an open top and a bottom portion that abuts the heating pad and includes an extension receiving the heating rod. The lid body covers the open top and includes an upper housing, a platform, a power module, and a light-emitting module.

### CROSS-REFERENCE TO RELATED APPLICATIONS

This application claims priority to U.S. Application No. 63/776,021, filed on Mar. 22, 2025, entitled DUAL-PURPOSE WAX MELTER AND LIGHTING DEVICE, which is incorporated herein by reference in its entirety.

### FIELD OF THE INVENTION

The present disclosure relates to electric wax melting devices, and more particularly, to a portable electric wax melting device having a modular three-section structure, which includes a central heating rod to provide uniform heating and a built-in rechargeable battery module to enable wireless operation.

### BACKGROUND OF THE INVENTION

Wax melting devices have been applied in residential, commercial, and outdoor environments to release fragrance from scented wax materials. Traditional wax melting methods include direct flame combustion methods, in which a wick embedded in the wax material is ignited to generate heat, melting the surrounding wax and releasing aromatic compounds into the ambient air. Alternative methods employ lamp-type heating configurations, directing a high-temperature light source toward an upper surface of the wax material to achieve melting through radiant heat transfer.

Direct flame combustion methods present various safety considerations, including potential fire hazards when candles are accidentally tipped over, particularly in environments with children or pets. The combustion process may also produce soot, smoke, and other byproducts, affecting indoor air quality. Temperature control during flame-type melting processes is typically limited, as heat output depends on flame characteristics rather than user-adjustable parameters.

Lamp-type wax melting devices address some issues associated with open flames by eliminating direct combustion. However, such devices typically apply heat to an upper surface of the wax material, potentially resulting in uneven melting patterns where the surface layer liquefies while lower portions of the wax remain solid. This surface-focused heating approach may reduce the overall utilization efficiency of the wax material. Additionally, lamp components and surrounding surfaces of such devices may reach elevated temperatures during operation, requiring consideration of operational safety when users wish to reposition the device or access the wax container.

Electrically-powered wax melting devices typically require connection to an external power source via a power cord, which may limit placement options to locations near electrical outlets. This wired configuration may restrict the flexibility of using such devices in outdoor environments, during travel, or in spaces where electrical outlet locations are inconvenient. The structural complexity of some existing wax melting devices, which may include multiple separable components with intricate assembly requirements, poses challenges for cleaning, maintenance, and parts replacement.

Accordingly, there is general interest in the industry for wax melting device configurations that can address considerations of heating uniformity, portability, operational safety, and maintenance convenience.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an aspect of the present disclosure, a portable electric wax melting device is provided. The portable electric wax melting device includes a main unit base, a cup body, and a lid body. The main unit base includes a housing provided with a control module. The main unit base includes a heating assembly including a heating pad and a heating rod, the heating pad being disposed on a top surface of the housing, and the heating rod passing through a center of the heating pad and extending vertically upward. The main unit base includes a temperature control module electrically connected to the heating rod and the heating pad, respectively. The main unit base includes a battery module electrically connected to the temperature control module. The main unit base includes a charging management module electrically connected to the battery module, wherein the control module on the housing is also electrically connected to the temperature control module and the charging management module. The cup body is configured to be removably positioned on the main unit base, the cup body having an open top end and a bottom portion, the bottom portion having an extension configured to receive the heating rod therein, and the bottom portion abutting the heating pad. The lid body is configured to be removably positioned on the open top end of the cup body. The lid body includes an upper housing, a top surface of which includes a plurality of openings, the plurality of openings being radially arranged around a central region, and the top surface of the upper housing includes a switch for ergonomically removing the lid body. The lid body includes a platform mountable on an inner side of the upper housing, a hollow upright plate being disposed along a circumferential direction around a periphery of the platform, and a lower end opening of the hollow upright plate being in air communication with an interior of the cup body, and an upper end of the hollow upright plate corresponding to the plurality of openings, wherein the platform and the upper housing form a first accommodation space. The lid body includes a power module disposed in the first accommodation space. The lid body includes a light-emitting module disposed on a bottom surface of the platform, and the light-emitting module is electrically connected to the power module.

According to other aspects of the present disclosure, the portable electric wax melting device may include one or more of the following features. The switch may be a plurality of finger recesses, and the finger recesses may be disposed on opposite sides of the top surface of the upper housing. The hollow upright plate may be a plurality of hollow upright plates, the plurality of hollow upright plates may be circumferentially arranged, each hollow upright plate may define an airflow channel, and the airflow channel may communicate with a corresponding opening of the plurality of openings. The power module in the lid body may include a battery, and the light-emitting module may include an LED. The lid body may further include a fan module, the fan module may be disposed on a bottom surface of the platform of the lid body and may be electrically connected to the power module. The control module of the main unit base may be electrically connected to the fan module. The cup body may have a heat resistance temperature of 400~500° C. The cup body may be a single-layer borosilicate glass container. A material of the cup body may include high-temperature photosensitive resin or polyetheretherketone. The cup body may include a second accommodation space and a third accommodation space, and the second accommodation space may accommodate the lid body. The third accommodation space of the cup body may be used to fill a wax block. A material of the wax block may include at least one of soy wax, beeswax, paraffin wax, palm wax, or coconut wax. The heating pad or the heating rod may be configured to provide uniform heating at a temperature of approximately 50 to 60 degrees Celsius. The main unit base may further include a display module, which may be electrically connected to the control module, and the display module may be disposed on a surface of the housing of the main unit base. The main unit base may further include a charging port electrically connected to the charging management module. The battery module may be a built-in lithium battery, which may support the portable electric wax melting device to continuously operate for 2 to 8 hours in an unplugged state. The main unit base may further include a second light-emitting module, the second light-emitting module may be disposed on the top surface of the housing and located around a periphery of the heating pad. The main unit base may further include a speaker module electrically connected to the control module of the main unit base. The cup body and the main unit base may be coupled via an interlocking connection, wherein the bottom portion of the cup body may include an annular groove, and the annular groove may be configured to engage with an annular protrusion on the top surface of the housing. The portable electric wax melting device may further include a cloud management system communicatively connected to the control module, the charging management module, and the temperature control module for remote monitoring and control.

The general description of the foregoing illustrative embodiments and the following detailed description are merely exemplary aspects of the teachings of the present disclosure and are not restrictive.

### BRIEF DESCRIPTION OF DRAWINGS

Non-limiting and non-exhaustive examples are described with reference to the following drawings.

FIG. 1 is a perspective view of a specific embodiment of the portable electric wax melting device of the present disclosure.

FIG. 2 is another perspective view of a specific embodiment of the portable electric wax melting device of the present disclosure.

FIG. 3 is a top perspective view of a specific embodiment of the portable electric wax melting device of the present disclosure, with the lid body removed.

FIG. 4 is an exploded perspective view of a specific embodiment of the portable electric wax melting device of the present disclosure.

FIG. 5 is another exploded perspective view of a specific embodiment of the portable electric wax melting device of the present disclosure.

FIG. 6 is a front cross-sectional view of a specific embodiment of the portable electric wax melting device of the present disclosure.

FIG. 7 is a perspective view of a specific embodiment of the lid body of the present disclosure.

FIG. 8 is another perspective view of the specific embodiment of the lid body of FIG. 7.

FIG. 9 is a perspective view of a specific embodiment of the upper housing of the present disclosure.

FIG. 10 is another perspective view of a specific embodiment of the upper housing of the present disclosure.

FIG. 11 is an isometric perspective view of the interior of a specific embodiment of the lid body of the present disclosure.

FIG. 12 is a perspective view of a specific embodiment of the portable electric wax melting device of the present disclosure, with the lid body removed.

FIG. 13 is an isometric perspective view of a specific embodiment of the main unit base of the present disclosure, according to aspects of the present disclosure.

FIG. 14 is an exploded isometric perspective view of a specific embodiment of the power module and base assembly of the present disclosure.

FIG. 15 is a system configuration block diagram of another specific embodiment of the portable electric wax melting device of the present disclosure.

### DETAILED DESCRIPTION OF THE INVENTION

The following description sets forth exemplary aspects of the present disclosure. However, it should be recognized that such description is not intended to limit the scope of the present disclosure. Rather, the description also covers combinations and modifications of the exemplary aspects described herein.

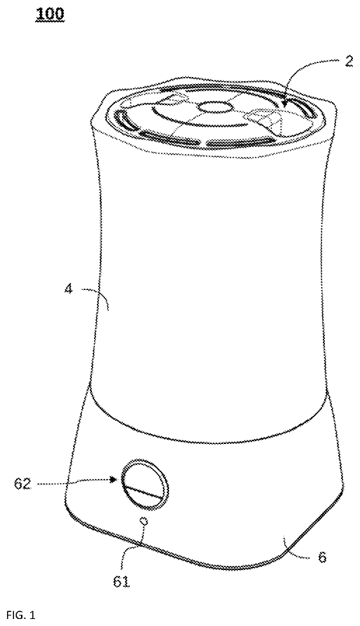

Referring to FIG. 1, a portable electric wax melting device 100 includes a modular three-section structure, providing a separable configuration. The portable electric wax melting device 100 includes a lid body 2, a cup body 4, and a main unit base 6. The lid body 2, the cup body 4, and the main unit base 6 are each independently detachable and assemblable, enabling maintenance convenience, product expandability, and parts replacement efficiency. The lid body 2 may be positioned at a top of the portable electric wax melting device 100. The lid body 2 includes a dish-shaped configuration having a plurality of elongated streamlined openings 222 radially arranged around a central region 21. The openings 222 may provide channels for fragrance diffusion and heat circulation. The lid body 2 further includes finger recesses 224 disposed on opposite sides of a top surface of the lid body 2. The finger recesses 224 may provide an ergonomic gripping interface for safely removing the lid body 2. The cup body 4 may be positioned between the lid body 2 and the main unit base 6. The cup body 4 includes a cylindrical container configuration having smooth continuous walls. An upper portion of the cup body 4 may be wider and gradually tapers toward a bottom. The cup body 4 may receive and contain wax material for melting operations. The main unit base 6 may be positioned at a bottom of the portable electric wax melting device 100. The main unit base 6 includes a rounded compact configuration. The main unit base 6 includes a control module 62 disposed on a front surface of the main unit base 6. The control module 62 may include a circular knob appearance with linear indicator markings on a surface thereof. An indicator light 61 may be disposed below the control module 62 to display operational status.

Continuing to refer to FIG. 1, the lid body 2 and the cup body 4 may be connected using a snap-fit connection, a magnetic connection, a threaded connection, or a clip-type connection. In some embodiments, the snap-fit connection between the lid body 2 and the cup body 4 may include a lower edge of the lid body 2 having an inwardly extending annular flange that forms a tight fit with an outer wall of an upper edge of the cup body 4. The cup body 4 and the main unit base 6 may be connected using a snap-fit connection having an annular groove and a protrusion, a magnetic connection having annularly arranged magnetic elements, or positioning posts and corresponding positioning holes. In some embodiments, a bottom portion of the cup body 4 may include an annular groove that engages with an annular protrusion on an upper surface of the main unit base 6 to form a stable positioning structure. In some embodiments, the cup body 4 and the main unit base 6 may include annularly arranged magnetic elements disposed at a bottom of the cup body 4 and on an upper surface of the main unit base 6, respectively, to achieve rapid and precise positioning. In some embodiments, the main unit base 6 may include three or four equally spaced positioning posts, and the cup body 4 may include corresponding positioning holes at a bottom thereof to achieve precise positioning through engagement of the positioning posts and the positioning holes.

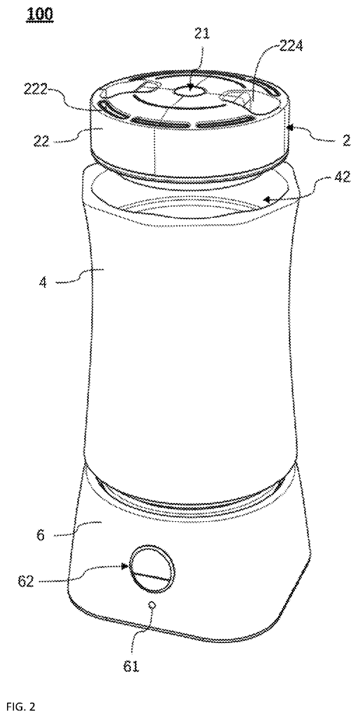

Referring to FIG. 2, the portable electric wax melting device 100 is shown in a fully assembled state from a slightly elevated front angle. The lid body 2 is positioned at a top of the device and includes an upper housing 22. The upper housing 22 has a dish-shaped appearance, and a top surface thereof includes a plurality of openings 222 radially arranged around a central region 21. The plurality of openings 222 may have an elongated streamlined configuration with rounded ends, and the plurality of openings 222 may be configured to facilitate fragrance diffusion and heat circulation during device operation. The top surface of the upper housing 22 includes a switch, and the top surface of the upper housing 22 further includes finger recesses 224 disposed on opposite sides thereof. The finger recesses 224 may provide an ergonomic gripping surface for removing the lid body 2 from the cup body 4, enabling users to safely lift the lid body 2 without contacting hot surfaces.

Continuing to refer to FIG. 2, the lid body 2 is configured to be removably positioned on an open top end of the cup body 4. A second accommodation space 42 is visible at a junction between the lid body 2 and the cup body 4. The second accommodation space 42 may be defined by an annular region configured to receive a lower edge portion of the lid body 2 when the lid body 2 is assembled onto the cup body 4. The connection between the lid body 2 and the cup body 4 may employ a snap-fit engagement, wherein a lower edge of the lid body 2 may include an inwardly extending annular flange that forms a tight fit with an outer wall of an upper edge of the cup body 4. This snap-fit configuration may enable the lid body 2 to be stably positioned on the cup body 4 without the use of tools or additional fasteners. The cup body 4 is shown as a cylindrical container having smooth continuous walls, wherein an upper portion of the cup body 4 is wider and tapers toward a bottom portion. The main unit base 6 is positioned at a bottom of the assembly and has a rounded compact configuration. The main unit base 6 includes a control module 62 on a front surface thereof, and an indicator light 61 is disposed below the control module 62.

In some embodiments, the portable electric wax melting device 100 may be designed as a two-section structure, wherein the lid body 2 and the cup body 4 are integrally formed as a single component, separate from the main unit base 6. This configuration may simplify the assembly process and may be suitable for usage scenarios that do not require frequent replacement of the lid body 2. In other cases, the portable electric wax melting device 100 may be designed as a four-section or five-section structure. For example, the main unit base 6 may be further separated into a battery module and a heating module as independent components. Alternatively, the lid body 2 may be separated into a diffuser lid and a decorative ring as two independent components, thereby providing greater customization flexibility.

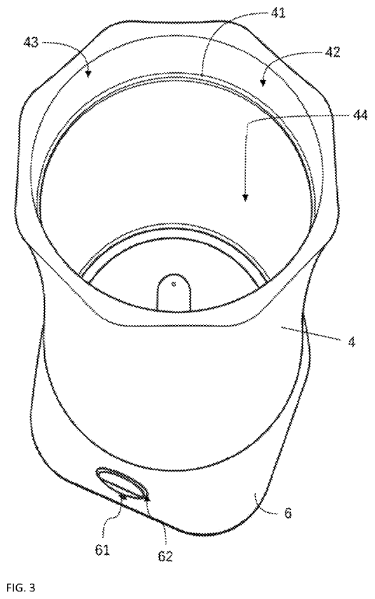

Referring to FIG. 3, when the lid body 2 is removed from the portable electric wax melting device 100, an opening of the cup body 4 is fully exposed, enabling fragrance to diffuse directly upward and providing a more intense fragrance release. The cup body 4 includes a convex structure 41 disposed at an upper edge of the cup body 4. The convex structure 41 forms a wavy profile along a circumferential direction, creating a decorative scalloped pattern that provides aesthetic appeal and tactile variation for users during operation. The cup body 4 includes an open top end 43 disposed below the convex structure 41. The open top end 43 defines an upper boundary of the cup body 4 through which fragrance may escape when the lid body 2 is removed. The cup body 4 further includes a second accommodation space 42, which may be configured as a recessed band-shaped region disposed below the convex structure 41. The second accommodation space 42 may accommodate the lid body 2 when the lid body 2 is assembled onto the cup body 4. Further, the cup body 4 includes a third accommodation space 44 disposed in an interior of the cup body 4. The third accommodation space 44 constitutes a main cavity for containing wax material. The third accommodation space 44 may be used to fill a wax block therein. A heating rod 632 extends upward from the main unit base 6 into a central portion of the third accommodation space 44. The heating rod 632 includes a dome-shaped top end configured to conduct heat to surrounding wax material disposed within the third accommodation space 44.

In some embodiments, an alternative mesh lid or grille lid having a larger opening area may be provided as a replacement for the standard lid body 2. Users may select between the standard lid body 2, a mesh lid, or complete removal of the lid body 2 based on the desired fragrance intensity. In some embodiments, the lid body 2 may be designed as an adjustable structure, wherein users may rotate the lid body 2 to adjust the size of airflow hole openings, thereby controlling the fragrance release intensity.

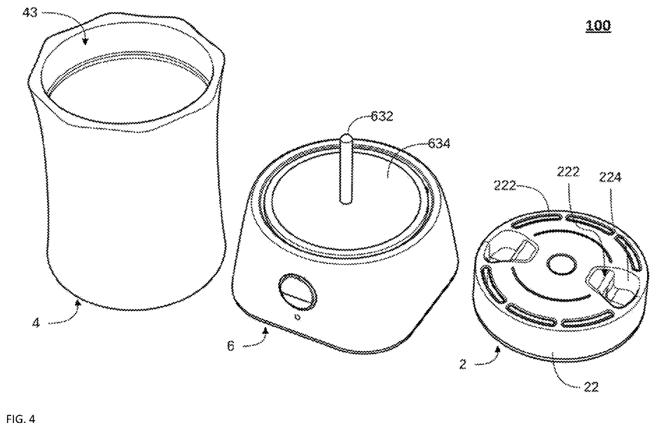

Referring to FIG. 4, the portable electric wax melting device 100 is shown in an exploded perspective view, with three main separable components arranged from left to right in a lateral configuration. This exploded view illustrates the modular three-section detachable structure of the device, with the cup body 4 on the left, the main unit base 6 in the center, and the lid body 2 on the right. The cup body 4 is configured to be removably positioned on the main unit base 6. The cup body 4 has an open top end 43 and a bottom portion 45. The cup body 4 may have a cylindrical configuration with smooth continuous walls, wherein an upper portion of the cup body 4 is wider and gradually tapers toward the bottom portion 45. In some embodiments, the cup body 4 has an inner diameter at the opening of approximately 87.26 mm and an outer diameter of approximately 99.93 to 100 mm. The total height of the cup body 4 from the bottom to the edge is approximately 122.20 mm. In some embodiments, the edge thickness of the cup body 4 is approximately 6.33 mm, the spacing between inner and outer walls is approximately 7.13 mm, and the bottom thickness is approximately 6.35 mm.

Continuing to refer to FIG. 4, the bottom portion 45 of the cup body 4 includes an extension configured to receive a heating rod 632 therein. The extension may have an inverted U-shaped or arched profile to accommodate and contact the heating rod 632 extending from the main unit base 6. When the cup body 4 is assembled onto the main unit base 6, the bottom portion 45 abuts a heating pad 634 of the main unit base 6. The cup body 4 and the main unit base 6 may be coupled via an interlocking connection. In some embodiments, the bottom portion 45 of the cup body 4 includes an annular groove configured to engage with an annular protrusion on a top surface of a housing of the main unit base 6. This interlocking connection provides stable positioning of the cup body 4 on the main unit base 6 during normal use while allowing removal of the cup body 4 from the main unit base 6 when cleaning or replacement is required.

As further shown in FIG. 4, the main unit base 6 has a rounded compact configuration. The heating pad 634 is positioned on a top surface of the main unit base 6. The heating rod 632 extends vertically upward from a center of the heating pad 634, and a distal end of the heating rod 632 has a dome-shaped top end. When the cup body 4 is positioned on the main unit base 6, the heating rod 632 is configured to be received within the extension of the bottom portion 45 of the cup body 4. The lid body 2 is shown from an angled perspective, illustrating the upper housing 22 having a top surface. A plurality of openings 222 are radially arranged around a central region of the top surface of the upper housing 22. Finger recesses 224 are positioned on opposite sides of the top surface of the upper housing 22. The lid body 2 may be removably positioned on the cup body 4 through a snap-fit connection, wherein a lower edge of the lid body 2 engages with an upper edge of the cup body 4. The finger recesses 224 provide an ergonomic gripping surface, enabling users to safely lift the lid body 2 from the cup body 4 without contacting hot surfaces.

Referring to FIG. 5, the portable electric wax melting device 100 is shown in an exploded perspective view from a slightly elevated front angle, illustrating a vertical separation of the main components. The lid body 2 is positioned at a top of the assembly, and a platform 24 is visible within the lid body 2. The platform 24 may be mounted on an inner side of the upper housing 22, and the platform 24 serves as a mounting base for various electronic components within the lid body 2. The platform 24 includes a plurality of hollow upright plates 242 disposed along a circumferential direction around a periphery of the platform 24. Each hollow upright plate 242 forms an independent airflow channel in an interior thereof. A lower end opening 244 of each hollow upright plate 242 extends downward and may be in air communication with an interior of the cup body 4. An upper end of each hollow upright plate 242 corresponds to the plurality of openings 222 on the upper housing 22, thereby establishing multiple airflow guiding paths from an interior cavity of the cup body 4 to an external environment. The platform 24 and the upper housing 22 together form a first accommodation space. A power module 246 is disposed within the first accommodation space. In some embodiments, the power module 246 includes a battery, such as a built-in lithium battery 2462. The built-in lithium battery 2462 may be cylindrical and horizontally positioned within an internal chamber of the lid body 2. The power module 246 may further include a circuit board disposed adjacent to the battery, with various electronic components on the circuit board including capacitors, connectors, and control circuits. A first light-emitting module 248 is disposed on a bottom surface of the platform 24. The first light-emitting module 248 is electrically connected to the power module 246. In some embodiments, the first light-emitting module 248 includes an LED. The first light-emitting module 248 may project downward into the cup body 4 to enhance visual ambiance during operation.

Continuing to refer to FIG. 5, the main unit base 6 is positioned at a bottom of the assembly. The main unit base 6 includes a housing 65 that forms an outer enclosure of the main unit base 6. The housing 65 is provided with a control module 62 on a front surface thereof. A button 621 is disposed on the control module 62, and the button 621 may have a circular knob appearance with linear indicator markings on a surface thereof. An indicator light 61 is positioned below the control module 62. A heating assembly 63 is disposed between the cup body 4 and the main unit base 6. The heating assembly 63 includes a heating pad 634 and a heating rod 632. The heating pad 634 is disposed on a top surface of the housing 65. The heating rod 632 passes through a center of the heating pad 634 and extends vertically upward. The heating rod 632 has a height of approximately 57 mm and a maximum outer diameter of approximately 6 mm, providing sufficient mechanical strength while maintaining an appropriately slender profile. The heating rod 632 may be made of high-temperature resistant metal or ceramic material, enabling the heating rod 632 to maintain structural stability during repeated heating cycles. In some embodiments, the heating rod 632 includes electric heating wires internally. In other cases, the heating rod 632 may be indirectly heated by the heating pad 634. A battery module 64 is disposed within the main unit base 6. The battery module 64 may include a plurality of lithium battery cells arranged in a parallel configuration to provide electrical power for device operation. A charging management module 66 is disposed on a circuit board within the main unit base 6. The charging management module 66 is electrically connected to the battery module 64 to monitor battery voltage, current, and charging status, and to perform charging control functions. The battery module 64 is electrically connected to a temperature control module, enabling the temperature control module to obtain battery level information and adjust heating power or operating modes accordingly.

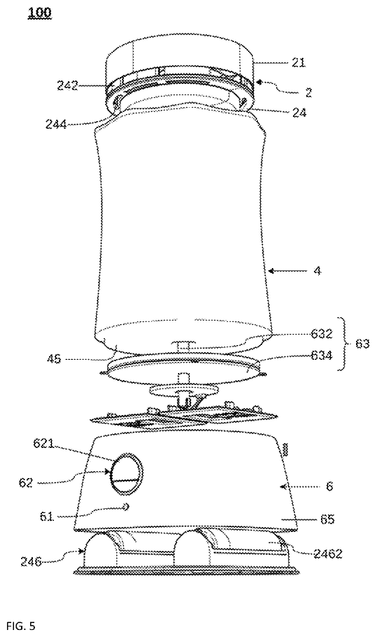

Referring to FIG. 6, a cross-sectional view of the portable electric wax melting device is shown from a front angle, revealing the internal structural configuration and vertical heat conduction path. The cross-sectional view illustrates how various components are vertically stacked and interconnected to achieve effective heat transfer from the main unit base to the wax material within the cup body. A heating rod extends vertically upward from a heating pad positioned at an interface between the cup body and the main unit base. The heating rod passes through an extension formed at a bottom of the cup body, the extension having an inverted U-shaped or arched profile, creating a receiving space configured to accommodate and contact the heating rod. The heating rod extends into a third accommodation space defined within the cup body, the third accommodation space constituting a main cavity for containing wax material. The heating rod has a dome-shaped top end and may include longitudinal grooves along its surface to enhance heat dissipation and increase contact surface area with surrounding wax material.

Continuing to refer to FIG. 6, the heating pad is positioned to abut a bottom portion of the cup body. The heating pad has a disc-shaped configuration with a diameter matching the bottom of the cup body, providing a stable heat transfer contact surface. The heating pad may be configured to provide uniform heating at approximately 50 to 60 degrees Celsius, with a temperature of approximately 55 degrees Celsius in some embodiments. This temperature range allows effective melting of various wax materials while maintaining safe operating conditions. The cup body may be formed of borosilicate glass material, which can withstand temperatures of 400 to 500 degrees Celsius without cracking or deformation. The borosilicate glass material has a low coefficient of thermal expansion, enabling the cup body to maintain structural stability during repeated heating and cooling cycles. The cup body includes a convex structure at an upper edge thereof and tapers from a wider upper portion toward a narrower bottom portion.

Further, a battery module is disposed within a housing of the main unit base, positioned below the heating pad. The battery module may include a built-in lithium battery configured to provide electrical power for device operation in an unplugged state. The battery module is electrically connected to a temperature control module, as previously described regarding the system configuration. The temperature control module is electrically connected to the heating rod and the heating pad, respectively, enabling it to control the electrical power supplied to these heating elements and to implement constant temperature or over-temperature protection functions. A charging management module is electrically connected to the battery module, the charging management module being configured to manage charging and discharging states of the battery module and to provide protection mechanisms. A control module disposed on the housing of the main unit base is electrically connected to the temperature control module and the charging management module, respectively, enabling users to input operational commands and obtain operating status or battery level information. A vertical heat conduction path extends from the battery module through the temperature control module to the heating pad and the heating rod, with thermal energy being transferred radially outward from the heating rod to the wax material and upward from the heating pad through the bottom portion of the cup body. This dual heating configuration, wherein the heating rod provides central heating and the heating pad provides bottom heating, enables uniform melting of the wax material within the third accommodation space.

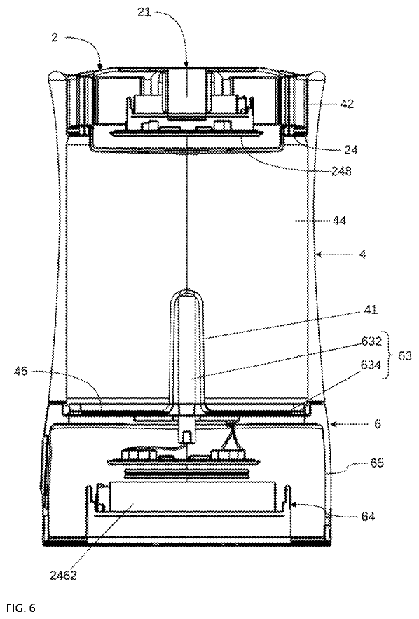

Referring to FIG. 7, the lid body 2 includes an overall dish-shaped configuration having an upper housing 22, the upper housing 22 having a top surface and an internal bottom surface structure. The top surface of the upper housing 22 includes a plurality of elongated streamlined openings 222 radially arranged around a central region 21. Each opening 222 has rounded ends and may be configured for fragrance diffusion and heat circulation. The plurality of openings 222 may be distributed in a circumferentially spaced manner, with a long side of each opening 222 extending substantially parallel to a circumferential direction. A switch 23 may be positioned on the top surface of the upper housing 22, located near one of the finger recesses 224. The switch 23 may include a plurality of finger recesses 224, and the finger recesses 224 may be disposed on opposite sides of the top surface of the upper housing 22. The finger recesses 224 may be formed as arcuate depressions, providing an ergonomic gripping function for safely removing the lid body 2. In some embodiments, the finger recesses 224 have a depth of approximately 8 to 15 mm and a width of approximately 20 to 30 mm to accommodate the finger pads of adult fingers. Inner surfaces of the finger recesses 224 may include anti-slip textures or may be treated with a material having a high coefficient of friction to enhance gripping stability. Edges of the finger recesses 224 may be rounded to avoid sharp edges causing discomfort or scratching to users' fingers.

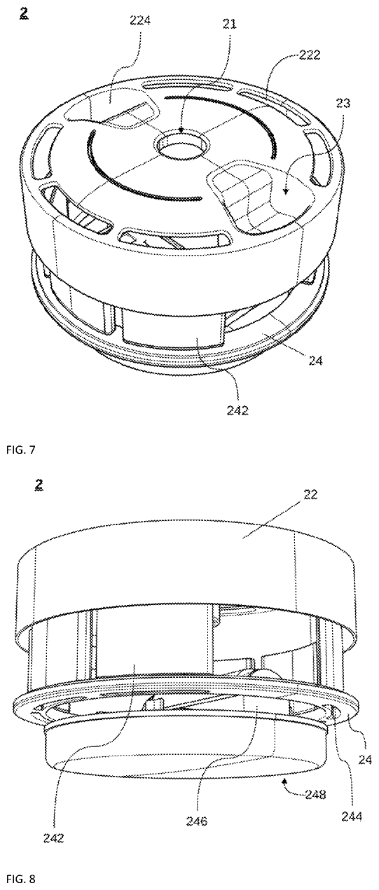

Referring to FIG. 8, the lid body 2 includes the upper housing 22 positioned above a platform 24. The platform 24 may be disposed on an inner side of the lid body 2, having a plurality of hollow upright plates 242 arranged in a circumferential direction around a periphery of the platform 24. The plurality of hollow upright plates 242 may be arranged in a circumferential configuration, and each hollow upright plate 242 may define an airflow channel 2422. The airflow channel 2422 of each hollow upright plate 242 may communicate with a corresponding opening of the plurality of openings 222, thereby establishing airflow paths from an interior of the cup body 4 to an external environment through the lid body 2. A lower end opening 244 of the hollow upright plates 242 may extend downward and may be configured to be in air communication with the interior of the cup body 4. Inner walls or openings of the hollow upright plates 242 may optionally be equipped with filters, baffles, or dust-proof elements to regulate airflow volume, filter impurities, or prevent foreign objects from entering the airflow channels 2422. The lid body 2 may include an annular elastic sealing element on an inner side thereof, and the annular elastic sealing element may compress when contacting an edge of the cup body 4 to prevent liquid leakage from the interface and absorb assembly tolerances.

As further shown in FIG. 8, the lid body 2 may include pressing regions on opposite sides of the top surface, and the pressing regions may be connected to flex arms, pivot plates, or sliding elements inside the lid body 2. When a user presses one of the pressing regions, the internal components may undergo elastic flexing or displacement, causing an annular flange to locally disengage from an outer wall of an upper edge of the cup body 4, thereby releasing the snap-fit engagement force. This configuration may enable the user to lift or detach the lid body 2 from above the cup body 4. When the pressing force is released, the internal components may restore the annular flange to its original engagement position under material elastic recovery, enabling the lid body 2 to re-establish a secure snap-fit engagement with the outer wall of the upper edge of the cup body 4.

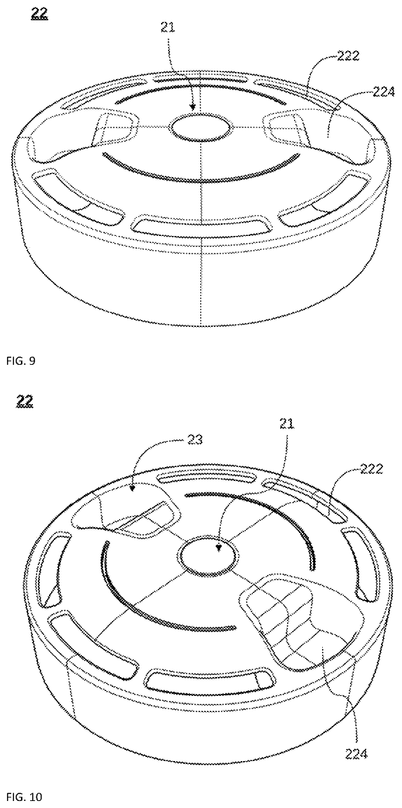

Referring to FIG. 9, an upper housing 22 of the lid body 2 is shown from an elevated front angle. The upper housing 22 may have a dish-shaped circular design with a low cylindrical side wall. A top surface of the upper housing 22 may include a plurality of elongated streamlined openings 222 arranged in a radially symmetrical manner around a central region 21, the openings 222 having rounded ends. The openings 222 may be configured to facilitate fragrance diffusion and heat circulation, enabling fragrant air from within the cup body to diffuse through the openings 222 to the surrounding environment. The streamlined configuration of the openings 222 may promote smooth airflow while maintaining an aesthetic appearance. Finger recesses 224 may be disposed on opposite sides of the top surface of the upper housing 22. Each finger recess 224 may have an arcuate depression, providing an ergonomic gripping feature. The finger recesses 224 may enable users to securely grip the lid body 2 when removing the lid body 2 from the cup body. The arcuate depression of each finger recess 224 may be sized and shaped to accommodate a user's fingertips, enabling stable gripping during lifting operations.

Referring to FIG. 10, the upper housing 22 is shown from an elevated angle different from FIG. 9. As further shown in FIG. 10, the upper housing 22 may have a dish-shaped configuration with a top surface having a slightly arched dome shape. A plurality of elongated streamlined openings 222 may be arranged in a radial manner around the central region 21, each opening 222 having a curved smooth profile. Finger recesses 224 are visible on opposite sides of the top surface, each finger recess 224 having an arcuate depression and an ergonomic profile contour for safely lifting the lid body 2. A switch 23 may be disposed on the top surface, positioned near one of the finger recesses 224. In some embodiments, the lid body 2 may be made of heat-resistant plastic. Suitable heat-resistant plastic materials may include polycarbonate, polyetheretherketone, or polyphenylene sulfide. These heat-resistant plastic materials may provide thermal stability during wax melting device operation while maintaining structural integrity. In some embodiments, the lid body 2 may be made of metal. Suitable metal materials may include aluminum alloy, stainless steel, or brass. Metal materials may provide enhanced durability and heat dissipation characteristics. In some embodiments, the lid body 2 may be made of ceramic material or wood. Ceramic materials may provide thermal insulation properties and aesthetic appeal. Wood may provide a natural appearance and may be suitable for decorative applications where heat exposure is limited to an upper portion of the lid body 2.

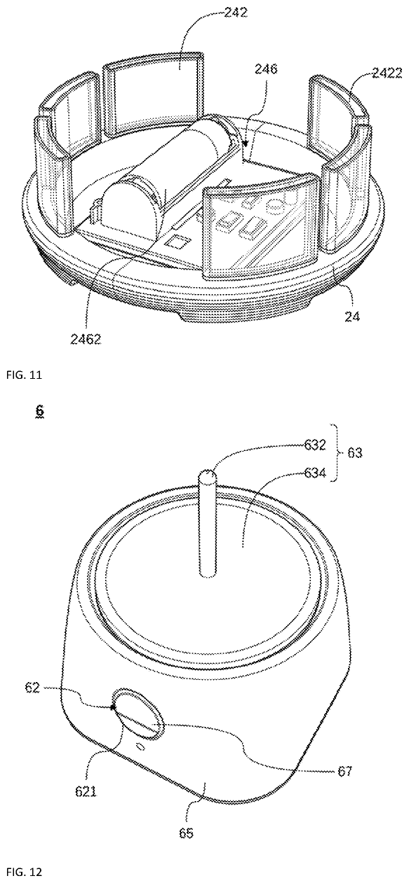

Referring to FIG. 11, the lid body 2 includes a platform 24 disposed within an interior of the lid body 2. The platform 24 may have a disc-shaped configuration with a stepped profile edge at a bottom thereof. A plurality of hollow upright plates 242 may be disposed along a circumferential direction around a periphery of the platform 24. Each hollow upright plate 242 may have an arcuate panel structure with an arched hollow design. The hollow upright plates 242 define an airflow channel 2422 therebetween, and the airflow channel 2422 may facilitate airflow circulation between an interior of the cup body 4 and an external environment through the openings 222 on the upper housing 22. A built-in lithium battery 2462 may be disposed within an internal chamber of the platform 24. The built-in lithium battery 2462 may have a cylindrical configuration and may be horizontally positioned within the internal chamber, occupying a majority of the available space. A power module 246 may be disposed adjacent to the built-in lithium battery 2462. The power module 246 may include a circuit board having various electronic components thereon, including capacitors, connectors, and control circuits. The power module 246 may be electrically connected to the built-in lithium battery 2462 to receive electrical power therefrom.

As previously described, the first light-emitting module 248 may be disposed on a bottom surface of the platform 24 and may be electrically connected to the power module 246. The lid body 2 may further include a fan module 26. The fan module 26 may be disposed on a bottom surface of the platform 24 and may be electrically connected to the power module 246. The fan module 26 may actively generate airflow to facilitate air being discharged more rapidly or more effectively from within the cup body 4 through the hollow upright plates 242 and the airflow channels 2422 to the external environment via the openings 222. The control module 62 on the main unit base 6 may be communicatively connected to the fan module 26 in the lid body 2. The control module 62 on the main unit base 6 may also be communicatively connected to the first light-emitting module 248 in the lid body 2. Through these communication connections, a user may adjust a fan speed of the fan module 26 via the control module 62. The user may also adjust a light color or brightness of the first light-emitting module 248 via the control module 62, thereby enabling customization of operational parameters based on user preferences or environmental conditions.

Referring to FIG. 12, the portable electric wax melting device is shown with the lid body 2 removed, revealing the appearance of the main unit base 6 and the configuration of the internal heating assembly. The cup body is shown as a cylindrical container having smooth continuous walls, with an upper portion being wider and tapering toward a bottom, and having a wide circular opening at a top thereof. A heating assembly 63 is positioned within the cup body and includes a heating rod 632 and a heating pad 634. The heating rod 632 extends vertically upward from a center of the heating pad 634 and has a dome-shaped top end configured to conduct heat to surrounding wax material. The heating pad 634 provides a flat surface area for uniformly distributing heat to a bottom portion of the cup body. The main unit base 6 includes a housing 65, the housing 65 forming an outer enclosure of the main unit base 6. The housing 65 has a rounded compact profile, providing a stable base for the device. A control module 62 is disposed on a front surface of the housing 65. The control module 62 has a circular knob appearance with linear indicator markings on a surface thereof. A button 621 is disposed on the control module 62 for user operation. A display module 67 is disposed below the control module 62 on a surface of the housing 65 of the main unit base 6. The display module 67 may be electrically connected to the control module 62. The display module 67 may provide visual feedback regarding operational status, temperature settings, or battery level information. A top surface of the main unit base 6 may include a second light-emitting module around a periphery of the heating pad 634. The second light-emitting module may be connected to the control module 62 or the display module 67, enabling users to control lighting effects based on preferences or environmental requirements.

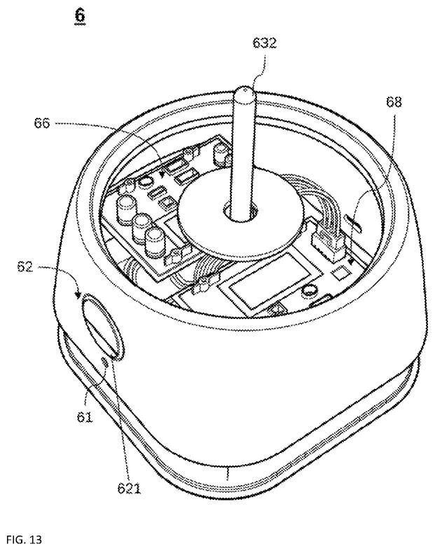

Referring to FIG. 13, the main unit base 6 includes an internal electronic component configuration integrating control and heating functions. The main unit base 6 has a rounded compact profile with a control module 62 disposed on a front surface thereof, and an indicator light 61 positioned below the control module 62. A button 621 may be disposed near the control module 62. A top surface of the main unit base 6 is open to reveal a circular recessed platform containing a circuit board and various electronic components. A heating rod 632 extends vertically upward from a center of a circular heating pad, with a distal end thereof having a dome-shaped top end. The circuit board supports a charging management module 66, which may appear as a rectangular component, and a temperature control module 68. Other electronic components such as capacitors, resistors, connectors, and wiring connections may be disposed on the circuit board. The temperature control module 68 may be configured to sense and regulate an operating temperature of the heating assembly. The temperature control module 68 may be electrically connected to the heating rod 632 and the heating pad, thereby controlling the electrical power supplied to the heating rod 632 and the heating pad. The temperature control module 68 may implement constant temperature maintenance or over-temperature protection functions based on temperature sensing results. The charging management module 66 may be configured to manage charging and discharging states of the battery module and provide protection mechanisms. The charging management module 66 may be electrically connected to the battery module to monitor battery voltage, current, and charging status, and to perform charging control operations. As shown, the main unit base 6 may further include a charging port, such as a TYPE-C charging port, the charging port being electrically connected to the charging management module 66. The charging port may provide multiple power supply modes for the portable electric wax melting device. The electronic control system and heating elements within the main unit base 6 are integrated in a coordinated configuration, wherein the control module 62 serves as a central interface for user operation and system management.

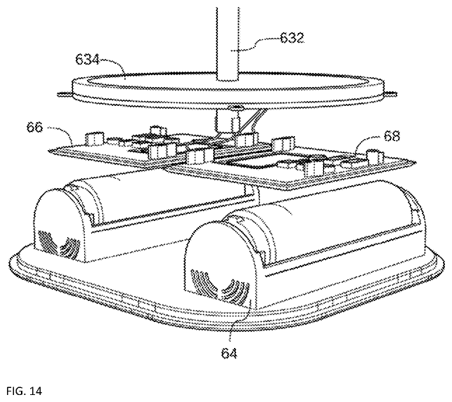

Referring to FIG. 14, a rechargeable power module and base assembly of the portable electric wax melting device is shown in an exploded isometric perspective view, illustrating the layered stacking and spatial configuration of internal components. The assembly includes, from bottom to top, a base housing, a battery module 64, a circuit board, and a heating pad 634 with a heating rod 632. The base housing may have a rounded rectangular profile with raised peripheral edges and a flat bottom surface, providing structural support and enclosure for internal electronic components. Three cylindrical lithium battery cells may be placed within the base housing, arranged in a side-by-side parallel configuration, occupying a majority of the internal space. Each battery cell may be encapsulated within an independent bracket, with ventilation slots visible at both ends to facilitate heat dissipation during charging and discharging operations. The battery module 64 may include overcharge protection, over-discharge protection, and short-circuit protection mechanisms. These protection mechanisms may help maintain operational safety and extend battery lifespan by preventing damage caused by excessively high charging voltages, deep discharge states, and electrical faults. In some embodiments, the battery module 64 may be a built-in lithium battery that may support the portable electric wax melting device to continuously operate for 2 to 8 hours in an unplugged state, thereby enabling wireless portable use in various environments where external power sources are unavailable.

As further shown in FIG. 14, a flat rectangular circuit board may be positioned above the battery compartment, spanning a width of the base assembly and serving as a control and power management platform. The circuit board may be provided with various electronic components, including capacitors, resistors, connection terminals, a charging management module 66 represented by a central rectangular component, and other small components distributed across the board surface. Wiring connections may connect the circuit board components to a central connector assembly for electrical communication with other modules. A vertical column corresponding to the heating rod 632 may extend upward from a center of the circuit board, passing through an uppermost element of the assembly. The heating pad 634 may be positioned at a top of the exploded assembly as a disc-shaped element having a central opening for the heating rod 632 to pass through. The heating pad 634 may have a flat wide surface area configured to provide uniform heating to a bottom portion of a cup body placed thereon. This vertical stacking relationship between the heating pad 634 and the heating rod 632 establishes a heat conduction path from the base assembly through a center of the wax material within the cup body.

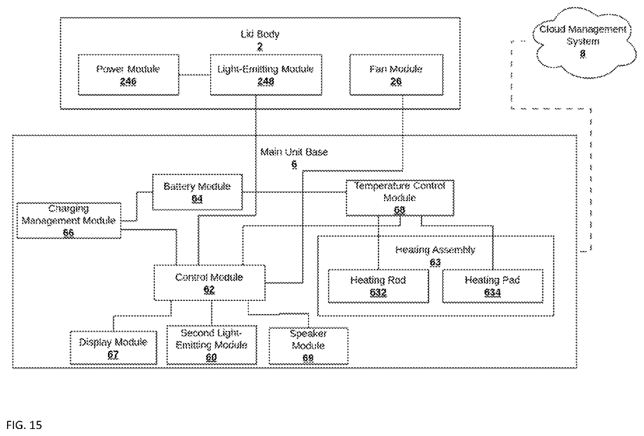

Referring to FIG. 15, a system configuration block diagram illustrates the electrical connections between various electronic modules of the portable electric wax melting device 100. The portable electric wax melting device 100 includes the lid body 2, the cup body 4, and the main unit base 6, wherein the lid body 2 and the main unit base 6 include electronic components that communicate with each other and with external systems. The lid body 2 may include a power module 246, a first light-emitting module 248, and a fan module 26. The power module 246 may provide electrical power to the first light-emitting module 248 and the fan module 26 within the lid body 2. The fan module 26 may be disposed on a bottom surface of the platform 24 and may be electrically connected to the power module 246. The fan module 26 may actively generate airflow to facilitate air being discharged more rapidly or more effectively from within the cup body 4 through the hollow upright plates 242 to the external environment. The main unit base 6 may include a charging port, a charging management module 66, a battery module 64, a temperature control module 68, a control module 62, a heating assembly 63 (including the heating rod 632 and the heating pad 634), a display module 67, an indicator light 61, a second light-emitting module 60, and a speaker module 69. The charging port may be electrically connected to the charging management module 66 to provide multiple power supply modes for the portable electric wax melting device 100. The charging management module 66 may be electrically connected to the battery module 64 to monitor battery voltage, current, and charging status while performing charging control. The battery module 64 may be electrically connected to the temperature control module 68, enabling the temperature control module 68 to obtain battery level information and adjust heating power or operating modes accordingly. The temperature control module 68 may be electrically connected to the heating rod 632 and the heating pad 634, respectively, to control the electrical power supplied to the heating rod 632 and the heating pad 634. The temperature control module 68 may implement constant temperature or over-temperature protection functions based on temperature sensing results.

As further shown in FIG. 15, the control module 62 may serve as a central control core and may be electrically connected to the temperature control module 68, the charging management module 66, the display module 67, the indicator light 61, the second light-emitting module 60, and the speaker module 69, respectively. The control module 62 may also be communicatively connected to the first light-emitting module 248 and the fan module 26 in the lid body 2. A user may adjust a fan speed of the fan module 26 or a light color or brightness of the LED of the first light-emitting module 248 via the control module 62 on the main unit base 6 based on desired scenarios or requirements. The second light-emitting module 60 may be disposed on a top surface of the housing 65 and positioned around a periphery of the heating pad 634. The second light-emitting module 60 may be electrically connected to the control module 62, enabling users to control or adjust the second light-emitting module 60 based on requirements. The speaker module 69 may be included in the main unit base 6 and may be electrically connected to the control module 62 of the main unit base 6. The speaker module 69 may also be electrically connected to the battery module 64. A user may transmit audio to the speaker module 69 of the main unit base 6 via a smartphone or other smart device for playback, enabling the portable electric wax melting device 100 to be used as a portable speaker. The portable electric wax melting device 100 may further include a cloud management system 8. The cloud management system 8 may be communicatively connected to the control module 62, the charging management module 66, and the temperature control module 68 of the main unit base 6 for remote monitoring and control. The cloud management system 8 may be connected to a mobile device application via the Internet. After a user logs into a cloud management interface via a smartphone or other smart device, the user may perform remote operations on the wax melting device.

The cloud management system 8 may enable users to selectively control charging and discharging operations of the battery module 64, activate or deactivate overall power of the wax melting device, and preset or activate a preheating function. The preheating function may cause the heating rod 632 and the heating pad 634 to warm up to a target temperature at a predetermined time or upon receiving a remote command, and may subsequently be deactivated when desired. The cloud management system 8 may provide smart control functions for the portable electric wax melting device 100, including remote charging and discharging management, power activation, preheating, and deactivation. The cloud management system 8 may also be used to transmit and record operational status information of the wax melting device for user inquiry and subsequent management. The temperature control module 68 may upload real-time temperature values, operating modes, and heating duration data of the heating rod 632 and the heating pad 634 to the cloud management system 8. The charging management module 66 may transmit remaining battery level, charging and discharging current, charging cycle count, and abnormal events (such as overvoltage or overcurrent protection activation) of the battery module 64 to the cloud management system 8. The cloud management system 8 may store historical records according to preset periods and may display the records in numerical or graphical format on a mobile device interface, enabling users to monitor long-term usage conditions of the device and adjust usage habits. The recorded data may also serve as a reference for future function optimization or maintenance diagnostics. The cup body 4 may be formed of various materials according to application requirements and user preferences. In some embodiments, the cup body 4 is a single-layer borosilicate glass container. Borosilicate glass provides heat-resistant characteristics, enabling the cup body 4 to withstand a temperature range of approximately 400 to 500 degrees Celsius without cracking or deformation. The low coefficient of thermal expansion of borosilicate glass maintains structural stability during repeated heating and cooling cycles, making borosilicate glass suitable for long-term use in wax melting environments.

In some embodiments, the cup body 4 may be formed of soda-lime glass. Soda-lime glass provides an alternative glass material option with different thermal and optical characteristics. In some embodiments, the cup body 4 may be formed of quartz glass. Quartz glass provides heat-resistant characteristics suitable for high-temperature applications. In some embodiments, a material of the cup body 4 includes high-temperature photosensitive resin. High-temperature photosensitive resin enables the cup body 4 to be manufactured through a three-dimensional printing process, allowing fabrication of complex geometric shapes that are difficult to achieve through traditional glass blowing or mold forming techniques. In some embodiments, the material of the cup body 4 includes polyetheretherketone (PEEK). Polyetheretherketone provides heat resistance and mechanical strength suitable for wax melting applications. In some embodiments, the cup body 4 may be formed of ceramic material. Ceramic material provides thermal insulation properties that may extend the duration of melted wax after heating. In some embodiments, the cup body 4 may be formed of stainless steel. Stainless steel provides thermal conductivity that may accelerate melting of wax material. In some embodiments, the cup body 4 may be formed of food-grade silicone. Food-grade silicone provides flexibility and ease of removing wax material after cooling.

The cup body 4 may be designed in various external shapes. In some embodiments, the cup body 4 has a cylindrical shape. In some embodiments, the cup body 4 has a conical shape. A conical structure that is wider at the top and narrower at the bottom naturally concentrates wax material toward the central heating rod during melting, which may improve heating efficiency. In some embodiments, the cup body 4 has a spherical or elliptical structure with a flat contact surface at the bottom to ensure stable contact with the heating pad. In some embodiments, the cup body 4 has a square or other geometric shape. In some embodiments, the cup body 4 has an irregular artistic shape. In some embodiments, the cup body 4 has a wavy outer wall with periodic concave and convex undulations along the circumference, providing a decorative appearance and tactile variation. The cup body 4 may provide various capacity options. In some embodiments, the cup body 4 has a small portable capacity of approximately 50 to 80 milliliters, suitable for travel or personal spaces. In some embodiments, the cup body 4 has a standard desktop capacity of approximately 100 to 150 milliliters, suitable for general home environments. In some embodiments, the cup body 4 has a large capacity of approximately 200 to 300 milliliters, suitable for fragrance diffusion in larger spaces. Cup bodies of different capacities may be compatible with the same main unit base, enabling users to select a cup body of appropriate capacity based on usage scenarios without purchasing multiple complete devices.

The cup body may include various surface treatments and decorative configurations to enhance visual appeal and provide customization options. In some embodiments, an outer surface of the cup body may be frosted. The frosted treatment may present a soft translucent effect, giving the cup body a diffused appearance while partially obscuring the melting state of the internal wax material. The frosted treatment may provide a softer visual presentation than a transparent glass surface. In some embodiments, the cup body may be made of colored glass. Colored glass may include amber, cobalt blue, emerald green, or pink. The colored glass configuration may cause the portable electric wax melting device to present a unique color effect during operation. Other glass colors may also be adopted based on aesthetic preferences or interior design requirements. An outer surface of the cup body may include engraved patterns. Engraved patterns may include geometric patterns, floral patterns, abstract lines, or brand logos. Engraved patterns may add visual depth and texture to the cup body while also providing a tactile experience for users. Engraved patterns may be formed through etching, engraving, or mold forming processes applied to the glass material.

In some embodiments, an outer surface of the cup body may include printed patterns. Printed patterns may be applied using ceramic glaze printing techniques or glass painting techniques. Ceramic glaze printing or glass painting techniques may permanently fix printed patterns to the glass surface, providing durable decorative elements that are resistant to wear during normal use. The cup body may be manufactured using 3D printing technology. In some embodiments, 3D printing may employ heat-resistant resin materials. Heat-resistant resin materials may include high-temperature photosensitive resin or polyetheretherketone. This 3D printing manufacturing method may enable more complex geometric shapes that are difficult to achieve through traditional glass blowing or mold forming processes. In some embodiments, the cup body may be made of ceramic material. Ceramic material may have heat retention properties that may extend the heat retention duration of melted wax material. Ceramic material may be decorated with glaze to provide color and texture variation on the cup body surface. The cup body may be made of metal material. In some embodiments, the metal material may include stainless steel or aluminum alloy. Stainless steel or aluminum alloy may have thermal conductivity properties that may accelerate the melting process of wax material within the cup body. Metal surfaces may be treated with electroplating, anodizing, or sandblasting processes to provide various appearance effects. An inner wall surface of the cup body may optionally be smoothly treated. The smooth treatment of the inner wall surface may promote flow of melted wax material within the cup body. The smooth inner wall surface may also promote removal of residual wax material during cleaning operations.

The portable electric wax melting device may be used with various types of wax materials to accommodate different user preferences and application requirements. A wax block placed within the cup body may include a material of at least one of soy wax, beeswax, paraffin wax, palm wax, or coconut wax. In some embodiments, the wax block may include a mixture of two or more of these wax materials to achieve desired melting characteristics, burning duration, or fragrance diffusion properties. Soy wax is derived from soybean oil and may provide a clean burning option with a lower melting point suitable for the device heating temperature range. Beeswax is a natural wax produced by bees and may provide longer burning time and a subtle natural honey aroma. Paraffin wax is a petroleum-derived wax and may provide strong fragrance diffusion and is widely available in various formulations. Palm wax is obtained from palm oil and may create crystalline patterns when solidified and may provide moderate fragrance diffusion. Coconut wax is derived from coconut oil and may provide excellent fragrance retention and a creamy white appearance. The device may be used with scented wax of various fragrance profiles to suit different environments and personal preferences. Floral profiles may include rose, jasmine, lavender, gardenia, or lily fragrances. Fruity profiles may include citrus, apple, berry, peach, or tropical fruit fragrances. Woody profiles may include sandalwood, cedar, oud, pine, or vetiver fragrances. Herbal profiles may include eucalyptus, rosemary, mint, sage, or chamomile fragrances. Complex fragrances may combine multiple fragrance categories to create sophisticated aromatic experiences.

In some embodiments, the device may be used with unscented wax combined with essential oils, enabling users to customize fragrance intensity based on preferences and mix different essential oil combinations. The device may also be used with functional wax containing specific active ingredients. Functional wax options may include wax containing sleep-aid ingredients (such as lavender or chamomile extracts), wax containing refreshing ingredients (such as peppermint or citrus extracts), or wax containing mosquito-repellent ingredients (such as citronella or lemongrass extracts). These functional wax options may provide therapeutic or practical benefits beyond aromatic enjoyment.

A number of implementations have been described. Nevertheless, it will be understood that various modifications may be made without departing from the spirit and scope of the present disclosure. Accordingly, other implementations are within the scope of the following claims.

1. A portable electric wax melting device, comprising:
a main unit base, including:
a housing provided with a control module;
a heating assembly including a heating pad and a heating rod, the heating pad being disposed on a top surface of the housing, and the heating rod passing through a center of the heating pad and extending vertically upward;
a temperature control module electrically connected to the heating rod and the heating pad, respectively;
a battery module electrically connected to the temperature control module;
a charging management module electrically connected to the battery module, wherein the control module on the housing is also electrically connected to the temperature control module and the charging management module;
a cup body configured to be removably positioned on the main unit base, the cup body having an open top end and a bottom portion, the bottom portion having an extension configured to receive the heating rod therein, and the bottom portion abutting the heating pad; and
a lid body configured to be removably positioned on the open top end of the cup body, comprising:
an upper housing, a top surface of which includes a plurality of openings, the plurality of openings being radially arranged around a central region, and the top surface of the upper housing including a switch for ergonomically removing the lid body;
a platform mountable on an inner side of the upper housing, a hollow upright plate being disposed along a circumferential direction around a periphery of the platform, and a lower end opening of the hollow upright plate being in air communication with an interior of the cup body, an upper end of the hollow upright plate corresponding to the plurality of openings, wherein the platform and the upper housing form a first accommodation space;
a power module disposed in the first accommodation space;
a light-emitting module disposed on a bottom surface of the platform, and the light-emitting module being electrically connected to the power module.

2. The portable electric wax melting device of claim 1, wherein the switch is a plurality of finger recesses, and the finger recesses are disposed on opposite sides of the top surface of the upper housing.

3. The portable electric wax melting device of claim 1, wherein the hollow upright plate is a plurality of hollow upright plates, the plurality of hollow upright plates are circumferentially arranged, each hollow upright plate defines an airflow channel, and the airflow channel communicates with a corresponding opening of the plurality of openings.

4. The portable electric wax melting device of claim 1, wherein the power module in the lid body includes a battery and the light-emitting module includes an LED.

5. The portable electric wax melting device of claim 4, wherein the lid body further includes a fan module, and the fan module is disposed on a bottom surface of the platform of the lid body and is electrically connected to the power module.

6. The portable electric wax melting device of claim 5, wherein the control module of the main unit base is electrically connected to the fan module.

7. The portable electric wax melting device of claim 1, wherein the cup body has a heat resistance temperature of 400~500° C.

8. The portable electric wax melting device of claim 1, wherein the cup body is a single-layer borosilicate glass container.

9. The portable electric wax melting device of claim 1, wherein a material of the cup body includes high-temperature photosensitive resin or polyetheretherketone.

10. The portable electric wax melting device of claim 1, wherein the cup body includes a second accommodation space and a third accommodation space, and the second accommodation space accommodates the lid body.

11. The portable electric wax melting device of claim 10, wherein the third accommodation space of the cup body is used to fill a wax block.

12. The portable electric wax melting device of claim 11, wherein a material of the wax block includes at least one of soy wax, beeswax, paraffin wax, palm wax, or coconut wax.

13. The portable electric wax melting device of claim 1, wherein the heating pad or the heating rod is configured to provide uniform heating at a temperature of approximately 50 to 60 degrees Celsius.

14. The portable electric wax melting device of claim 1, wherein the main unit base further includes a display module, which is electrically connected to the control module, and the display module is disposed on a surface of the housing of the main unit base.

15. The portable electric wax melting device of claim 1, wherein the main unit base further includes a charging port electrically connected to the charging management module.

16. The portable electric wax melting device of claim 1, wherein the battery module is a built-in lithium battery, which supports the portable electric wax melting device to continuously operate for 2 to 8 hours in an unplugged state.

17. The portable electric wax melting device of claim 1, wherein the main unit base further includes a second light-emitting module, and the second light-emitting module is disposed on the top surface of the housing and located around a periphery of the heating pad.

18. The portable electric wax melting device of claim 1, wherein the main unit base further includes a speaker module electrically connected to the control module of the main unit base.

19. The portable electric wax melting device of claim 1, wherein the cup body and the main unit base are coupled via an interlocking connection, wherein the bottom portion of the cup body includes an annular groove, and the annular groove is configured to engage with an annular protrusion on the top surface of the housing.

20. The portable electric wax melting device of claim 1, further comprising a cloud management system communicatively connected to the control module, the charging management module, and the temperature control module for remote monitoring and control.
